(19) United States
(12) Patent Application Publication
(10) Pub. No.: US 2014/0344317 A1
(43) Pub. Date: Nov. 20, 2014

(54) Method for Protecting Network Uploaded Information and Storage Control System

(71) Applicants: MiTAC Research (Shanghai) Ltd., Shanghai (CN); MiTAC International Corp., Kuei San Township (TW)

(72) Inventor: Wei-Chiang Cho, Taoyuan City (TW)

(73) Assignees: MiTAC Research (Shanghai) Ltd., Shanghai (CN); MiTAC International Corp., Kuei San Township (TW)

(21) Appl. No.: 14/207,017

(22) Filed: Mar. 12, 2014

(30) Foreign Application Priority Data
May 17, 2013 (CN) 201310185714.X

(51) Int. Cl. G06F 17/30

(52) U.S. Cl. CPC G06F 17/30212
USPC 707/827

(57) ABSTRACT

A method for protecting network uploaded information and a storage control system. The method includes the following steps: performing a segmentation program for uploaded information by a storage control system; dividing the uploaded information to form a plurality of information segments by the storage control system after the segmentation process; and transmitting and storing the plurality of information segments respectively through the storage control system to a plurality ones of network storage space. In this way, the present invention may prevent the other user to crack and obtain the uploaded information easily.

### CROSS-REFERENCE TO RELATED APPLICATION

This application claims the benefit of China Patent Application No. 201310185714.X, filed on May 17, 2013, in the China Intellectual Property Office, the disclosure of which is incorporated herein in its entirety by reference.

### FIELD OF THE INVENTION

The present invention relates to a method and system for protecting information. More particularly, the present invention relates to a method for protecting network uploaded information and a storage control system that could be used to effectively prevent the other person to compromise and obtain the uploaded information of the network.

### BACKGROUND OF THE INVENTION

As science and technology advance, all kinds the advanced electronic products not only promote the convenience in daily living for people, but also the communications between people, without the limitations of distance and time. For example, the portable communication device can be used to improve the problem of the inconvenience caused by the limitation of the distance or location. The real-time communication between people can thereby be realized by the portable communication devices.

In addition, another advancement is the establishment of the internet sharing service platform, such as the Facebook, the Microblog, etc. In the past, when people want to share their experience, mood or picture with each other, they must use the phone to communicate, have a face to face conversation, or use physical mediums, such as the diary or album, to share information. However, the sharing methods as described above are limited by time and distance. And currently, people can share their experience, mood or picture with each other anytime and anywhere through writings, images, and other information by the internet sharing service platform.

However, because the sharing of the information is fast and convenient, the security of the information becomes an issue. At the present, if someone wants to steal information stored in the network storage space, they only need to crack a single network storage space, since it is where the whole information uploaded. Therefore, it is important to create a mechanism for protecting the uploaded information to prevent from being compromised or stolen by others.

### SUMMARY OF THE INVENTION

In view of the aforementioned drawbacks of the prior art, it is a primary objective of the present invention to provide a method for protecting network uploaded information and a storage control system to solve the problem of security issues of the network uploaded information.

To achieve the aforementioned objective, the present invention provides a method for protecting network uploaded information, which comprises the following steps: performing a segmentation program for uploaded information by a storage control system; dividing the uploaded information to form a plurality of information segments by the storage control system after the segmentation process; and transmitting and storing the plurality of information segments respectively through the storage control system to a plurality ones of network storage space.

Preferably, the storage control system comprises a redundant array of inexpensive disks 5 (RAID 5) controller, and the segmentation process is performed by the redundant array of inexpensive disks 5 controller.

Preferably, the method for protecting network uploaded information of the present invention further comprises the following steps of: generating a parity check code while performing the segmentation process, and transmitting and storing the parity check code by the storage control system to each of the network storage space along with each of the information segments.

Preferably, the uploaded information can be image information.

Preferably, when the image information is divided by the segmentation process, a plurality of image contents are derived from the image information, and each of the image contents are then transmitted and stored by the storage control system to a respective one of the network storage space.

To achieve the aforementioned objective, the present invention further provides a storage control system connected to a plurality of network storage space. The storage control system receives the uploaded information transmitted by a host device, and executes a segmentation process to divide the uploaded information to form a plurality of information segments, and transmits and stores each of the information segments to a respective one of the network storage space.

Preferably, the storage control system can be a redundant array of inexpensive disks 5 controller.

Preferably, the storage control system generates a parity check code when the segmentation process is performed, and transmits and stores the parity check code to each ones of the network storage space along with each of the information segments.

Preferably, the uploaded information can be image information.

Preferably, the storage control system is arranged for deriving a plurality of image contents from the image information, and transmitting and storing of each the image contents to each one of the network storage space while performing the segmentation process on the image information.

In summation, the method for protecting network uploaded information and the storage control system of the present invention can be used to divide the uploaded information to form the plurality of information segments and generate a plurality of parity check codes by the technology of RAID, and then transmit and store each of the information segments and each of the parity check codes to different ones of network storage space. As a result, if someone wants to compromise and download the whole uploaded information, then must obtain the data of at least the amount of the information segments regulated by RAID protocol and then recover the data in accordance with the RAID protocol. It is not sufficient to recover the complete uploaded information while only the data of the information segment in a single network storage space is obtained, so that the uploaded information can be protected effectively.

### BRIEF DESCRIPTION OF THE DRAWINGS

FIG. 1 is a flow chart of a method for protecting network uploaded information of the present invention.

FIG. 2 is a schematic view of a storage control system of a preferred embodiment of the present invention.

FIG. 3 is a schematic view of performing a segmentation process for image information of another preferred embodiment of the present invention.

### DESCRIPTION OF THE PREFERRED EMBODIMENTS

The technical characteristics, contents, advantages and effects of the present invention will be apparent with the detailed description of a preferred embodiment accompanied with related drawings as follows. The drawings are provided for the illustration, and the same numerals are used to represent respective elements in the preferred embodiments. It is intended that the embodiments and drawings disclosed herein are to be considered illustrative rather than restrictive. The same numerals are used for representing same respective elements in the drawings.

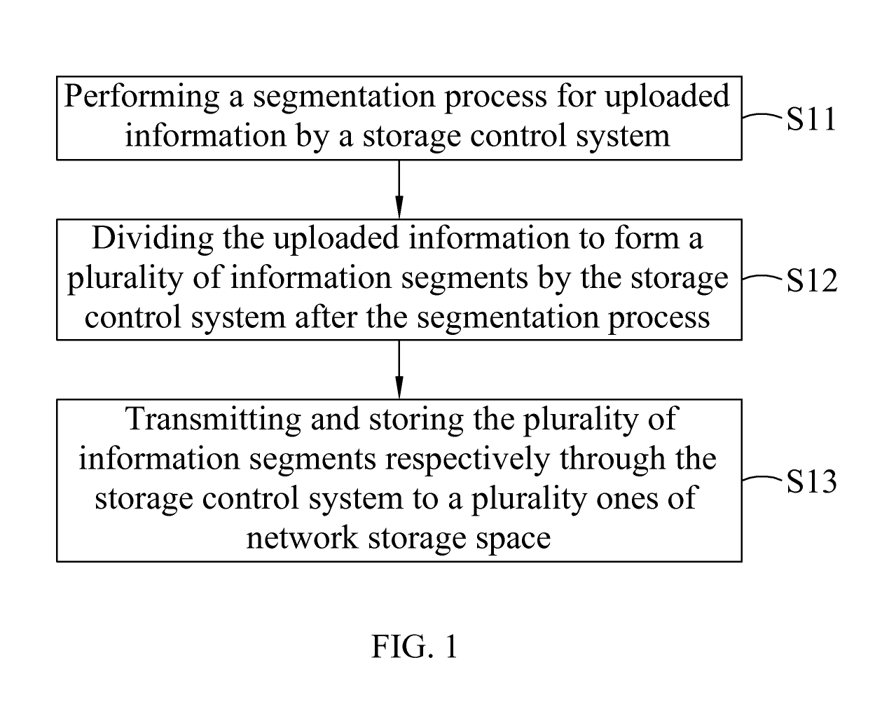

With reference to FIG. 1 for the flow chart of a method for protecting network uploaded information of the present invention. The following steps are performed in this method:

S11: A segmentation process is performed for the uploaded information by a storage control system.

S12: The uploaded information is divided to form a plurality of information segments by the storage control system after the segmentation process.

S13: The plurality of information segments are transmitted and stored respectively through the storage control system to a plurality ones of network storage space.

Wherein, the segmentation process can be performed by the redundant array of inexpensive disks 5 or 0 (RAID-5 or RAID-0) controller.

In the above, because the plurality of information segments are derived from the uploaded information and stored to different ones of the network storage space, the others must obtain the data of at least the amount of the information segments regulated by RAID protocol and then recover the data in accordance with the RAID protocol if they want to compromise and steal the uploaded information. As a result, the uploaded information can be protected effectively.

Furthermore, a plurality of parity check codes will be generated while performing the segmentation process for the uploaded information, and each of the parity check codes will be transmitted and stored to each of the network storage space along with each of the information segments. Such that, if one of the network storage space is failing and the corresponding information segment is damaged, the uploaded information can still be recovered by the information segments and the parity check codes stored in the other network storage space.

In addition, the uploaded information can be the image information, or the other data information. For example, the uploaded information can be the text information, etc. When the uploaded information is the image information, another segmentation pattern can be implemented while performing the segmentation process. For example, a plurality of image contents may be derived from the image information, and each of the image contents are then transmitted and stored to each of the network storage space. That is, although the uploaded image information is the complete picture while being displayed on the private website, the image information is divided while uploading so that each part of the picture is stored to a different one of the network storage space. As a result, the others must use such as the mosaic method to obtain all parts of the picture. The information segments as described above can be encoded data, but limited thereto.

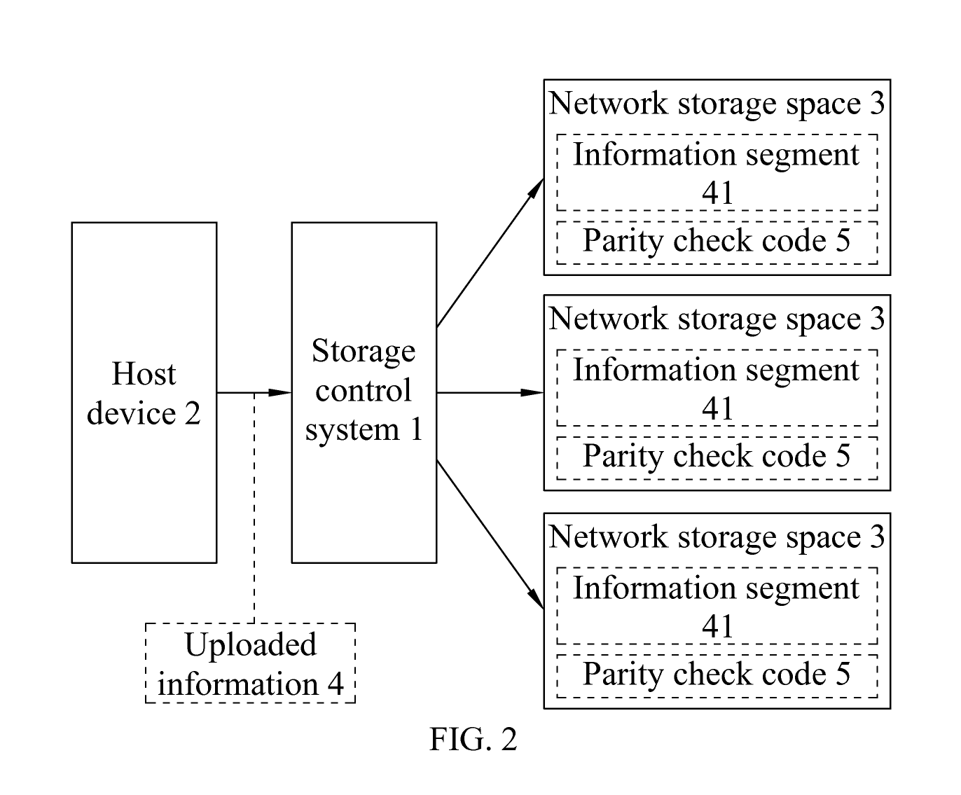

With reference to FIG. 2, that shows the schematic view of a storage control system of a preferred embodiment of the present invention. The storage control system 1 is connected to a host device 2 and the plurality ones of network storage space 3. The storage control system 1 is a redundant array of inexpensive series disks (RAID) controller. For example, the storage control system 1 can be a RAID-0 controller, or preferably can be a RAID-5 controller. In this embodiment, the storage control system 1 is the RAID-5 controller and comprises a data arrangement unit, a XOR operation unit, a transmission control unit and an access control unit.

As illustrated above, the host device 2 is arranged for providing the user to transmit the uploaded information 4. The storage control system 1 is arranged for receiving the uploaded information 4 and dividing the uploaded information 4 to form the plurality of information segments 41 through a segmentation process, and then transmitting and storing each of the information segments 41 to each of the network storage space 3 respectively. The storage control system 1 will generate a parity check code 5 while performing the segmentation process. The parity check code 5 can be the odd-even check code message. The parity check code 5 would be transmitted and stored to each of the network storage space 3 along with each of the information segments 41 by the storage control system 1. As a result, if the information segments 41 stored in one of the network storage space 3 is damaged, the uploaded information 4 can still be restored with the information segments 41 and the parity check codes 5 stored in the other network storage space 3. Wherein, the uploaded information 4 can be the image information, the character information, etc, and the information segment 41 can be the encoded data, etc.

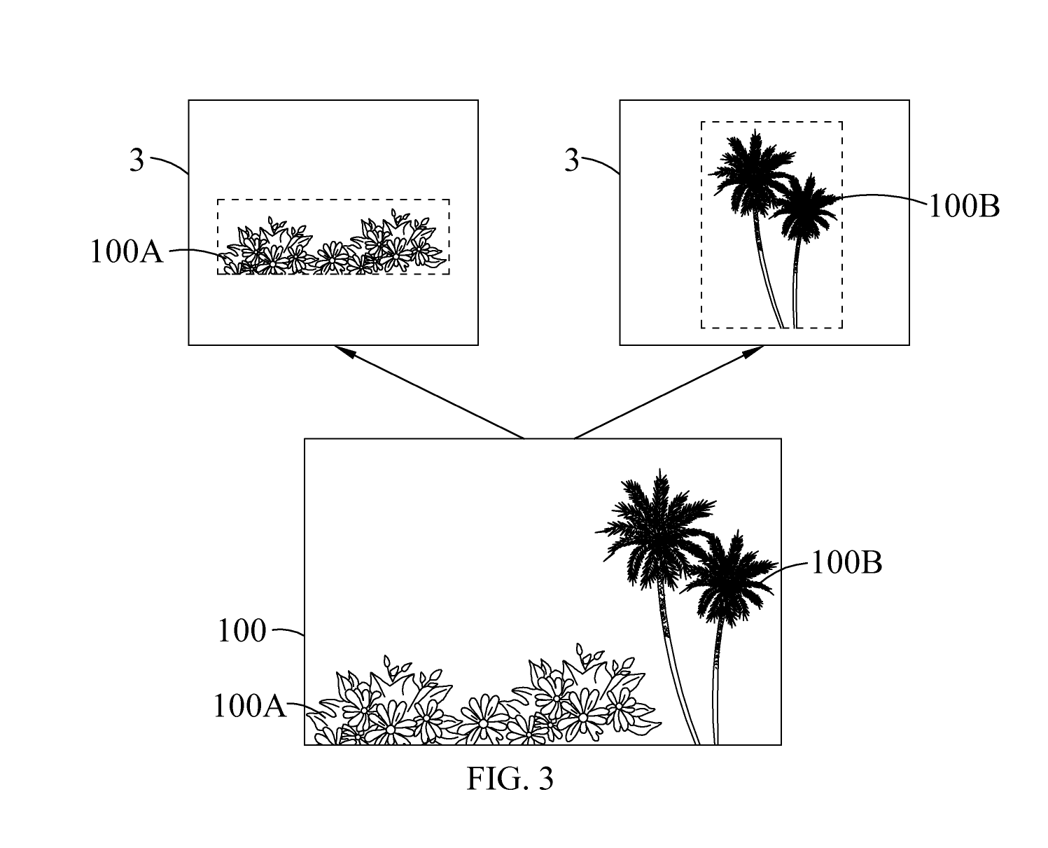

In addition, with reference to FIG. 3 that is a schematic view of performing a segmentation process for image information of another preferred embodiment of the present invention. In this embodiment, the uploaded information is image information 100, and a plurality of image contents 100A, 100B are derived from the image information 100 while performing the segmentation process for the image information 100. Each of the image contents 100A, 100B are transmitted and stored to each of the network storage space 3. That is, although the image information 100 displayed on a private website is a complete picture, the image contents 100A, 100B of the image information 100 are stored to different ones of the network storage space 3 respectively. As a result, the whole image information 100 would not be stolen if only one of the network storage space 3 is compromised and only one of the plurality of image contents 100A, 100B is obtained.

In summation of the description above, the method for protecting network uploaded information and the storage control system of the present invention can be used to divide the uploaded information to form the plurality of information segments by the technology of RAID, and then transmit and store each of the information segments and each of the parity check message to different ones of the network storage space. Thereof, if someone wants to steal and download the whole uploaded information, he must obtain the data of all the network storage space simultaneously. As a result, the uploaded information can be protected effectively, and would not be compromised and downloaded easily by others.

What is claimed is:

1. A method for protecting network uploaded information, comprising the following steps of:
performing a segmentation process for uploaded information by a storage control system;
dividing the uploaded information to form a plurality of information segments by the storage control system after the segmentation process; and
transmitting and storing the plurality of information segments respectively through the storage control system to a plurality ones of network storage space.

2. The method for protecting network uploaded information of claim 1, wherein the storage control system comprises a redundant array of inexpensive disks 5 (RAID 5) controller, and the segmentation process is performed by the redundant array of inexpensive disks 5 controller.

3. The method for protecting network uploaded information of claim 1, further comprising the following steps of:
generating a parity check code while performing the segmentation process, and transmitting and storing the parity check code by the storage control system to each of the network storage space along with each of the information segments.

4. The method for protecting network uploaded information of claim 1, wherein the uploaded information is image information.

5. The method for protecting network uploaded information of claim 4, wherein when the image information is divided by the segmentation process, a plurality of image contents are derived from the image information, and each of the image contents are then transmitted and stored by the storage control system to a respective one of the network storage space.

6. A storage control system connecting to a plurality of network storage space, and receiving uploaded information transmitted by a host device, and executing a segmentation process to divide the uploaded information to form a plurality of information segments, and transmitting and storing each of the information segments to a respective one of the network storage space.

7. The storage control system of claim 6, wherein the storage control system is a redundant array of inexpensive disks 5 controller.

8. The storage control system of claim 6, wherein the storage control system generates a parity check code when the segmentation process is performed, and transmits and stores the parity check code to each ones of the network storage space along with each of the information segments.

9. The storage control system of claim 6, wherein the uploaded information is image information.

10. The storage control system of claim 9, wherein the storage control system is arranged for deriving a plurality of image contents from the image information, and transmitting and storing of each the image contents to each one of the network storage space while performing the segmentation process on the image information.
